(19) United States
(12) Patent Application Publication
(10) Pub. No.: US 2014/0201180 A1
(43) Pub. Date: Jul. 17, 2014

(54) Intelligent Supplemental Search Engine Optimization

(71) Applicants: Mehrdad Fatourechi, Vancouver (CA); Shahrzad Rafati, Vancouver (CA); Hadi HadiZadeh, Burnaby (CA); Ivan Bajic, Vancouver (CA); Radu Matei Ripeanu, Vancouver (CA); Elizeu Santos-Neto, Vancouver (CA)

(72) Inventors: Mehrdad Fatourechi, Vancouver (CA); Shahrzad Rafati, Vancouver (CA); Hadi HadiZadeh, Burnaby (CA); Ivan Bajic, Vancouver (CA); Radu Matei Ripeanu, Vancouver (CA); Elizeu Santos-Neto, Vancouver (CA)

(73) Assignee: BroadbandTV, Corp., Vancouver (CA)

(21) Appl. No.: 14/028,238

(22) Filed: Sep. 16, 2013

Related U.S. Application Data
(60) Provisional application No. 61/701,319, filed on Sep. 14, 2012.
(60) Provisional application No. 61/701,478, filed on Sep. 14, 2012.
(60) Provisional application No. 61/758,877, filed on Jan. 31, 2013.

(51) Int. Cl. G06F 17/30

(52) U.S. Cl. CPC G06F 17/30442; G06F 17/30864; G06F 17/3053
USPC 707/706

(57) ABSTRACT

In accordance with one embodiment, an intelligent supplemental search engine optimization tool may generate keywords relating to content based on additional content collected from one or more data sources, wherein the data sources are selected based on initial input relating to the initial content. Data sources may include one or more third-party resources. A variety of processes may be employed to recommend keywords, including frequency-based and probabilistic-based recommendation processes.

This application claims the benefit under 35 U.S.C. §119(e) of U.S. provisional patent applications 61/701,319 filed on Sep. 14, 2012, 61/701,478 filed on Sep. 14, 2012, and 61/758,877 filed on Jan. 31, 2013, each of which is hereby incorporated by reference in its entirety and for all purposes.

### BACKGROUND

Online file and video sharing facilitated by video sharing websites such as YouTube.com™ have become increasingly popular in recent years. Users of such websites rely on keyword searches to locate user-provided content. Increased viewership of certain videos is desirable, especially by advertisers that display advertisements alongside videos or before, during, or after a video is played.

However, searches by users looking for video content are not always effective in locating the desired content. As a result, the searcher does not always find the best content that the searcher is looking for. And, the content uploaded by a content provider is not always made known to those searching for the content.

### SUMMARY

Embodiments described herein may be utilized to address at least one of the foregoing problems by providing a tool that generates keyword recommendations for content, such as a content file, based on additional content collected from one or more third-party resources. The third-party resources may be selected based on initial input relating to the original content. A variety of processes may also be employed to recommend keywords, such as frequency-based and probabilistic-based recommendation processes.

In accordance with one embodiment, a method is provided that comprises utilizing input data related to content to identify one or more data sources that are different from the content itself. Additional content can be collected from at least one of the one or more data sources as collected content. The collected content can then be used by a processor to generate at least one keyword based at least on the collected content and at least one relevancy condition.

In accordance with another embodiment, a system is provided that comprises a computerized user interface configured to accept input data relating to content so as to generate keywords for the content. A computerized keyword generation tool is configured to utilize the input data to collect additional content from at least one or more data sources different from the content itself. The computerized keyword generation tool is also configured to generate one or more keywords based on at least the collected content and at least one relevancy condition.

In accordance with yet another embodiment, one or more computer-readable storage media encoding computer-executable instructions for executing on a computer system a computer process that can accept input data relating to content so as to generate keywords for the content. The process can utilize input data related to content to identify one or more data sources that are different from the content itself. Additional content can be collected from at least one of the one or more data sources as collected content. The collected content can then be used by a processor to generate at least one keyword based at least on the collected content and at least one relevancy condition.

Further embodiments are apparent from the description below.

### BRIEF DESCRIPTIONS OF THE DRAWINGS

A further understanding of the nature and advantages of the present technology may be realized by reference to the figures, which are described in the remaining portion of the specification.

FIG. 1 illustrates an example of a user interface screen for use in modifying keywords associated with a content provider's content, in accordance with one embodiment.

FIG. 2 illustrates an example operation for supplemental keyword generation in accordance with one embodiment.

FIG. 3 illustrates a process for implementing a knapsack-based keyword recommendation process in accordance with one embodiment.

FIG. 4 illustrates a process of a greedy-based keyword recommendation process in accordance with one embodiment.

FIG. 5 illustrates a process for aggregating keywords generated by different keyword recommendation processes, in accordance with one embodiment.

FIG. 6 illustrates a process for determining top recommended keywords, in accordance with one embodiment.

FIG. 7 illustrates a process for extracting text from a video, in accordance with one embodiment.

FIG. 8 illustrates an example of a system for generating keyword(s) in accordance with one embodiment.

FIG. 9 illustrates an example computer system 200 that may be useful in implementing the described technology in accordance with one embodiment.

### DETAILED DESCRIPTION

Searches by users looking for particular online video content are not always effective because some methods of keyword generation do not consistently predict which keywords are likely to appear as search terms for user-provided content. For instance, a content provider uploading a video for sharing on YouTube or other video sharing websites can provide the search engine with metadata relating to the video such as a title, a description, a transcript of the video, and a number of tags or keywords. A subsequent keyword search matching one or more of these content-provider terms may succeed; but, many keyword searches fail because the user's search terms do not match those terms originally present in the metadata. Keywords chosen by content providers are often incomplete, irrelevant, or they may inadequately describe content in the corresponding file. Therefore, in accordance with one embodiment, a tool may be utilized that generates and suggests keywords relating to video content that are likely to be the basis of a future search for that content. Those keywords can then be added to the metadata describing the content or exchanged in place of existing metadata for the content.

By mining the content and/or third-party resources for enriching information relating to initial file descriptors (e.g., title, description, tags, etc.), this tool is able to consider synonyms of those file descriptors as well as other information that is either not known to or considered by the content provider. When the content or data collected from third-party resources is subsequently processed in the manner disclosed herein, the result is a list of one or more suggested keywords that are helpful to identify the content. In some instances, the new keywords will be more productive in attracting users to the associated content than keywords generated independently by the content provider.

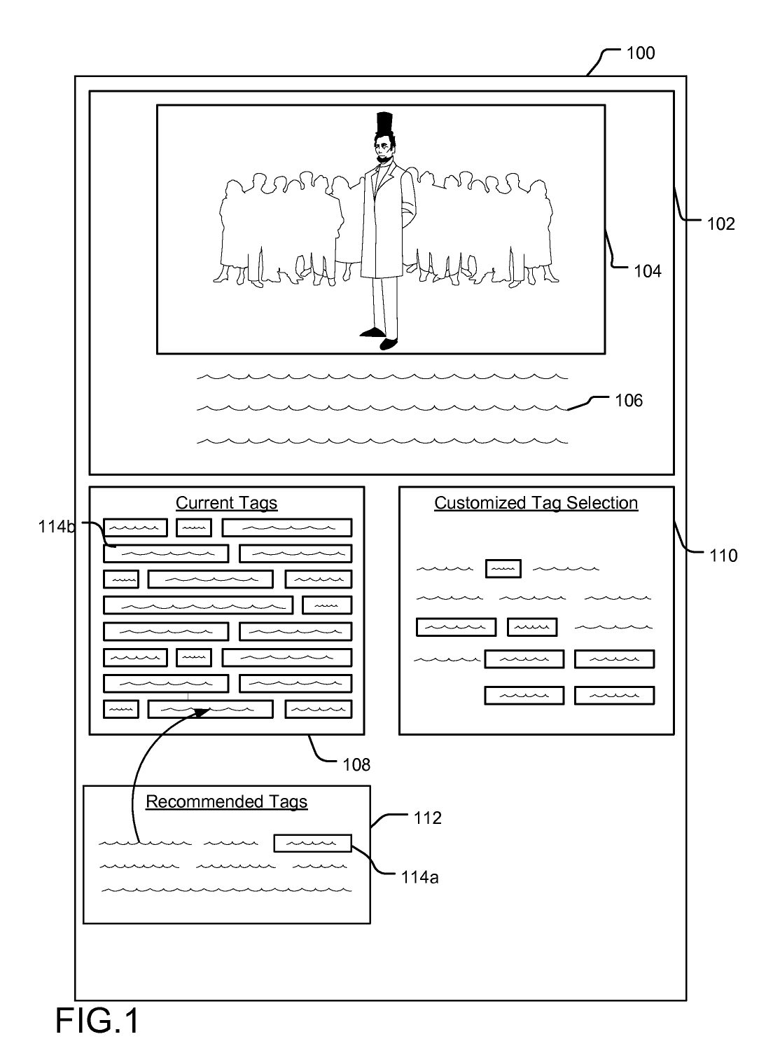

Referring now to FIG. 1, an example of a user interface screen 100 for the keyword tool can be seen. In FIG. 1, a content provider uploads data content to the user interface. The content in FIG. 1 is a video file 104 along with descriptive text 106. In addition, the content provider can provide original tag data. Initially this original tag data is shown in “Current Tags” section 108. Tags are word identifiers that are used by search engines to identify content on the internet. The tags are not necessarily displayed. Rather, in many instances tags act as hidden data that forms part of a file but that is not actually encoded for display. Thus, when a search engine reviews the data for a particular file, the search engine can process not only the displayed text information that will appear with a video, but also the hidden tag data. Tags are often described as metadata for content accessible over the Internet in that the metadata serves to highlight or act as a shorthand description of the actual data.

In accordance with this example, a computerized keyword generation tool utilizes the original content information, which can include the video 104, text 106, and original tag data, to generate new keywords from different data sources. The output of the keyword generation tool is shown in the recommended tag section 112.

In this example, the content provider reviews the recommended tags and decides whether to add one or more of the recommended tags to the Current Tag list. Oftentimes, a video sharing service will have a limited number of tags or characters that can be used for the tag data. For example, a content provider might be limited to a field of 500 characters for tag data by a video sharing site. Thus, FIG. 1 shows that when the content provider selects one of the Recommended Tags and pulls the selected-recommended-tag on top of a particular Current Tag, the previous current tag is replaced with the selected-recommended-tag from the recommended tag list. This is just one way that a tag could be added to the Current Tag list from the Recommended Tag section. The replaced tag can be displayed in a separate section on the user interface screen in case the content provider opts to add the replaced tag back into the Current Tag section.

Another way to merge tags is for the content creator to select and move tags from the Current Tags section 114b and the Recommended Tags section 114a to the Customized Tag Selection section 110. Users might also indicate in the settings page whether they always want their current tags to be included in Customized Tag selection. If the system is configured with such a setting, the system will include the Current Tags in the Customized Tag Selection section and if the space allows, also include one or more of the tags from the Recommended Tags section, as well. In another implementation, users might indicate in their Settings page that they want to give higher priority to the Recommended Tags suggested by the system and only if the space allows, one or more of current tags are used. When a recommended tag 114a is already present in the Current Tag section, an indicator, such as a rectangle drawn around the text for that tag, can be utilized to signal to a content provider that the same tag data 114b is already present in the Current Tag section.

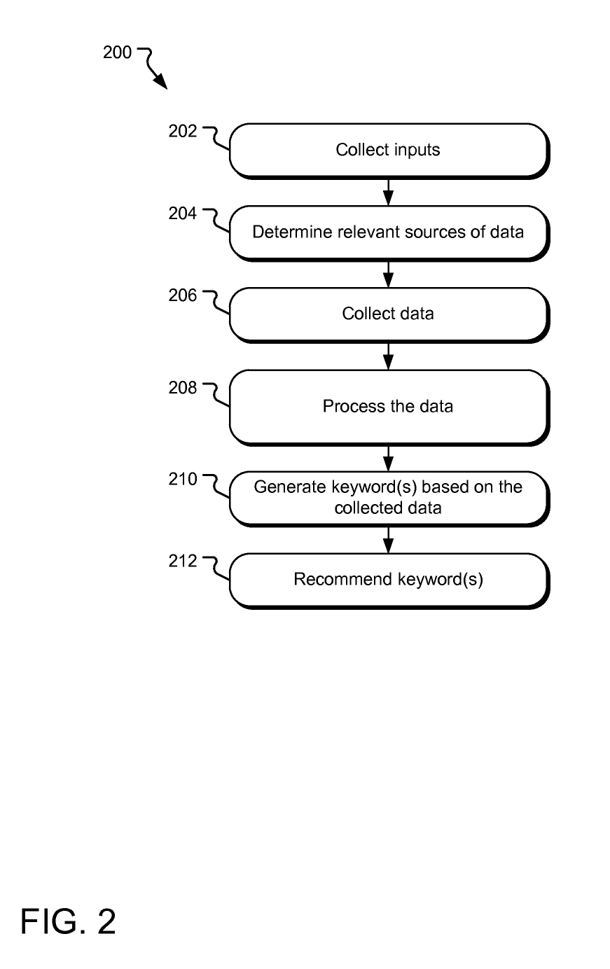

FIG. 2 is an example operation 200 for supplemental keyword generation. A collection operation 202 collects input data related to content, such as a content file. In one embodiment, the input data is provided by the user. For example, a content provider uploading a file may be prompted to provide various information regarding the file such as a title for the file, a description of the file content, a category describing a genre that the file relates to (e.g., games, movies, etc.), a transcript of the video, or to include one or more suggested tags or keywords to be associated with the file in subsequent searches. In another embodiment, the input data is the file itself and the keyword generation process is based on content mined from third-party data sources and/or information extracted from the file.

A determination operation 204 determines relevant sources of data based on the input collected. Data sources may include, for example, online textual information such as blogs and online encyclopedias, review websites, online news articles, educational websites, and information collected from web services and other software that generates tags and keyword searches.

For example, the content provider could upload a video titled “James Bond movie clips.” Using this title as input, the supplemental keyword generation tool may determine that Wikipedia.org is a data source and collect (via collection operation 206) from Wikipedia.org titles of various James Bond movies and names of actors who have appeared in those films.

In one embodiment, the supplemental keyword generation tool might further process the Title of the video to determine the main “topic” or the main “topics” of the video before passing the processed title to a data source such as Wikipedia, to collect additional information regarding possible keywords. For example, it might process a phrase such as “What I think about Abraham Lincoln” to get “Abraham Lincoln” and then search data sources for this particular phrase. The main reason for this pre-processing is that depending on the complexity of the query, the data sources may not be able to parse the input query, and so relevant information might not be retrieved.

In another embodiment, an algorithm can be used to process the input title and find the main topic of the video. In such an example algorithm, a variable “n-gram” is defined as a contiguous sequence of n words from a given string (text input), a number of strings of n words can be extracted from the string. For example, a 2-gram is a string of two consecutive words in the string; a 3-gram is a string of three consecutive words in the string, and so on. For example, “Abraham Lincoln” will be a 2-gram and “The Star Wars” will be a 3-gram. The algorithm may proceed as follows:
Step 1: Set a variable nₘₐₓ to a relatively large value. As an example nₘₐₓ can be equal to 4 or 5, where nₘₐₓ specifies the maximum size of the n-gram.
Step 2: Set the variable n to nₘₐₓ.
Step 3: Extract all the possible n-grams from the input query. For example, if the input query is “The Star Wars”, the 2-grams will be “The Star” and “Star Wars”.
Step 4: Check if there exists any information about each of the extracted n-grams in the online datasource of interest. If there is any information, then go to Step 7.
Step 5: Reduce n by one, and go to Step 3. If n is equal to zero, then end.
Step 6: Return the selected n-gram as a keyword, and then end the search.

The idea behind this algorithm is that larger n-grams carry more information than smaller n-grams. So, in one embodiment, if there is any information for a large n-gram, there is less of a need to try smaller n-grams. This increases the speed of the collection operation 206 (described below), and the overall quality of additional content retrieved by the collection operation 206. However, in another embodiment, the collection operation 206 may try collecting data related to all the possible n-grams of the video title string and suggest using data relevant to those n-grams for which some information is found in a datasource of interest.

A determination of which of the above-described data sources are relevant to given content may require an assessment of the type of content, such as the type of content in a content file. For instance, the content provider may be asked to select a category or genre describing the content (e.g., movies, games, non-profit, etc.) and the tool may select data sources based on the category selected. For example, RottenTomatoes.com™, a popular movie-review website, may be selected as a data source if the input indicates that the content relates to a movie. Alternatively, GiantBomb.com™, a popular video game review website, may be selected as a data source if the input indicates that the content relates to a video game.

In one embodiment, a content provider or the supplemental keyword generation tool may select a default category. As an example, a content creator who is “Musician” can select the default category as “Music”. In another embodiment, the keyword generation tool might analyze potential categories relevant to any of the n-grams extracted from the input text, and after querying the data sources, determine the category of the search. In another embodiment, the category selected is a category relevant to the longest-length n-gram parsed from the video title. In another embodiment, a majority category (i.e., a category relevant to a majority of the n-grams extracted from the text) determines the category describing the content. For example, the supplemental keyword generation tool may, for the input phrase “What I Liked about The Lord of the Rings and Peter Jackson”, determine that “The Lord of The Rings” is both the name of a book and a movie, and also that “Peter Jackson” is the name of a director. Since the majority of n-grams extracted belong to the category “Movie,” the supplemental keyword generation tool may then choose “Movie” as the category describing the content.

A collection operation 206 collects data from one or more of the aforementioned sources. A processing operation 208 processes the data collected. Processing may entail the use of one or more filters that remove keywords returned from the sources that do not carry important information. For instance, a filter may remove any of a number of commonly used words such as “the”, “am” “is”, “are”, etc. A filter may also be used to discard words whose length is shorter than, longer than, or equal to a specified length. A filter may remove words that are not in dictionaries or words that exist in a “black list” provided either by the user or generated automatically by a specific method. Another filter may also be used to discard words containing special punctuations or non-ASCII characters. The keyword generation tool may also recommend a set of “white-listed” keywords that a content provider may always want to use (e.g., their name or the type of content that they create).

Processing may also entail running one or more machine learning processes including, but not limited to, optical character recognition, lyrics recognition, object recognition, face recognition, scene recognition, and event recognition. In an embodiment where the data source is the file itself, the processing operation 208 utilizes an optical character recognition module (OCR) to extract text from the video. In one embodiment, processing further entails collecting information regarding the extracted text from additional data sources. For example, the tool might extract text using an OCR module and then run that text through a lyrics recognition module (LRM) to discover that the text is the refrain from a song by a certain singer. The tool may then select the singer's Wikipedia page as an additional data source and mine that page for additional information.

In one embodiment, the input data is metadata provided by a content provider and the data source is the content such as a content file. Here, the processing operation 208 may be an OCR module that extracts textual information from the video file. Keywords may then be recommended based on the text in the file and/or the metadata that is supplied by the content provider.

In another embodiment the data source is the file itself and the processing operation 208 is an object recognition module (ORM) that checks whether an uploaded video contains specific objects. If the object recognition process detects a specific object in the video, the name of that object may be recommended as a keyword or otherwise used in the keyword recommendation process. Similarly, the processing operation 208 may be a scene or event recognition module that detects and recognizes special places (e.g., famous buildings, historical places, etc.) or events (e.g., sport games, fireworks, etc.). The names of the detected places or scenes can then be used as keywords or otherwise in the keyword recommendation process.

In other embodiments, it may be desirable to extract information from the file and use that information to select and mine additional data sources. Here, processing operation 208 may entail extracting information from a video file (such as text, objects, or events obtained via the methods described above or otherwise) and mining one or more online websites that provide additional information related to the text, objects, or events that are known to exist in the file.

In another embodiment, the processing operation 208 is a tool that can extract information from the audio component of videos, such as a speech recognition module. For example, a speech recognition module may recognize speech in the video and convert it to text that can be used in the keyword recommendation process. Alternatively, the processing operation 208 may be a speaker recognition module that recognizes speakers in the video. Here, the names of the speakers may be used in the keyword recommendation process.

Alternatively, the processing operation 208 may be a music recognition module that recognizes the music used in the video and adds relevant terms such as the name of the composer, the singer, the album, or the song that may be used in the keyword recommendation process.

In another embodiment, the data collection operation 206 and/or the processing operation 208 may entail “crowd-sourcing” for recommending keywords. For instance, for a specific video game, a number of human experts can be recruited to recommend keywords. The keywords are then stored in a database (e.g., a data source) for each video game in a ranked order of decreasing importance, such that the more important keywords get a higher rank. In some instances, the supplemental keyword generation tool may determine that this database is a relevant data source and then search for and fetch relevant keywords

In practice, the number of recommended keywords by human experts may exceed the total number of allowed keywords in an application. If the number of expert-recommended keywords exceeds the total number of allowed keywords in an application, then some of the expert-recommended keywords may not be selectable. To mitigate this problem, in one embodiment, a weight can be assigned to each keyword in a given ranked list. There are various ways to determine the weight. In one embodiment, this weight can be computed as the position or the index of the keyword in the list divided by the total number of keywords in the list. Using this approach, those keywords that appear higher in the ranked list get a higher weight and the keywords that appear lower, get a lower weight. The list is then re-sorted based on a weighted random sort algorithm such as the “roulette wheel” weighting algorithm. Using this approach, even those keywords that have a small probability can have a chance to be selected by the supplemental keyword generation tool (albeit with a very small probability).

In another embodiment, the processing operation 208 may be performed on a string, such as a user input query, a string parsed from the video, or from one or more strings collected from a data source by the collection operation 206. For example, keywords might be extracted after parsing and analyzing the string. In one example, the supplemental keyword generation tool may find those words in the string that have at least two capital letters as important keywords. In another example, the supplemental keyword generation tool may select the phrases in the string that are enclosed by double quotes or parentheses. The supplemental keyword generation tool may also search for special words or characters in the string. For instance, if there is a word “featuring” or “feat.” in the query, the supplemental keyword generation tool may suggest the name of the person or entity that appears before or after this word as potential keywords.

In another embodiment, the processing operation 208 recommends the translation of some or all of the extracted keywords in different languages. In one implementation, the keyword generation tool may check to determine if there is any Wikipedia or any other online encyclopedia page about a specific keyword in another language than English. If such pages exist, the supplemental keyword generation tool may then grab the title of that Wikipedia page, and recommend it as a keyword. In another embodiment, a translation service can be used to translate the keywords into other languages.

In another embodiment, the processing operation 208 extracts possible keywords by using the content provider's social connections. For example, users may comment on the uploaded video and the processing operation 208 can use text provided by all users who comment as an additional source of information.

A keyword generation operation 210 generates a list of one or more of the best candidate keywords collected from the data sources. A keyword generation operation is, for example, a keyword recommendation module or a combination of keyword recommendation modules including, but not limited to, those processes discussed below. The keyword generation operation may be implemented, for example, by a computer running code to obtain a resultant list of keywords.

In one embodiment, the keyword generation operation 210 uses a frequency-based recommendation module to collect keywords or phrases from a given text and recommend keywords based on their frequency. Another embodiment utilizes a TF-IDF (Term Frequency-Inverse Document Frequency Recommender) that recommends keywords based on each word's TF-IDF score. The TF-IDF score is a numerical statistic reflecting a word's importance in a document. Alternate embodiments can utilize probabilistic-based recommendation modules.

In another embodiment, the keyword generation operation 210 uses a collaborative-based tag recommendation module. A collaborative-based tag recommendation module utilizes the data collected 206 to search for similar, already-tagged videos on the video-sharing website (e.g., YouTube) and uses the tags of those similar videos to recommend tags. A collaborative-based tag recommendation module may also recommend keywords based on the content provider's social connections. For example, a collaborative-based tag recommendation module may recommend keywords from videos recently watched by the content provider's social networking friends (e.g., Facebook™ friends). Alternatively, the keyword generation operation 210 may utilize a search-volume tag recommendation module to recommend popular search terms.

In yet another embodiment, keyword generation operation 210 may utilize a human expert for keyword recommendation. For example, a knowledgeable expert recruited from a relevant company may suggest keywords based on independent knowledge and/or upon the data collected.

The keyword generation operation 210 in this example produces a list of tags of arbitrary length. Some online video distribution systems, including websites such as YouTube, restrict the total length of keywords that can be utilized by content providers. For example, YouTube currently restricts the total length of all combined keywords to 500 characters. In order to satisfy this restriction, it may be desirable to recommend a subset of the keywords returned. This goal can be achieved through the use of several additional processes, discussed below.

In one embodiment, this goal is accomplished through the use of a knapsack-based keyword recommendation process which scores the keywords collected from the data sources, defines a binary knapsack problem, solves the problem, and recommends keywords to the user.

In another embodiment, this goal is accomplished through the use of a Greedy-based keyword recommendation process that factors in a weight for each keyword depending on its data source of origin and the type of video. For instance, a user may upload a video file and select the category “movie” as metadata. Here, data is gathered from a variety of sources including RottenTomatoes.com and Wikipedia. The data collected from RottenTomatoes may be afforded more weight than it would otherwise be because the video file has been categorized as a movie and RottenTomatoes is a website known for providing movie reviews and ratings.

In at least one embodiment, the supplemental keyword generation tool employs more than one of the aforementioned recommendation modules and aggregates the keywords generated by different modules.

A recommendation operation 212 recommends keywords. A recommendation operation may be performed one or more of the keyword recommendation modules described above. In one embodiment, the recommendations are presented to the content provider. In another embodiment, the keyword selection process is automated and machine language is employed to automatically associate the recommended keywords with the file such that the file can be found when a keyword search is performed on those recommended terms.

Aspects of these various operations are discussed in more detail below.

Inputs

Inputs utilized to select data sources for a supplemental keyword generation process may include, for example, the title of the video, the description of the video, the transcript of the video, information extracted from the audio or visual portion of the video or the tags that the content provider would like to include in the final recommended tags. A content creator on a video sharing website such as YouTube, may also specify a list of tags that should be excluded in the output results. Moreover, the content creators may specify the “category” of the uploaded video in the input query. The category is a parameter that can influence the keywords presented to the user. Examples of categories include but are not limited to games, music, sports, education, technology and movies. If the category is specified by the user, the recommended tags can then be selected based on the selected category. Hence, different categories will often result in different recommended keywords.

Data Sources

The input data for a supplemental keyword generation process can be obtained from various data sources. In one implementation, the inputs to the supplemental keyword generation process can be used to determine the relevant sources and tools for gathering data. For example, potential sources can be divided into the following general categories:

Text-based: any data source that can provide textual information (e.g., blogs or online encyclopedias) belongs to this category.

Video-based: any tool that can extract information from the visual component of videos (e.g., object and face recognition) belongs to this category.

Audio-based: any tool that can extract information from the audio component of videos (e.g., speech recognition) belongs to this category.

Social-based: any tool that can harness the social structure to collect the tags generated by content creators who had a social connection with the uploaded video. For instance, such a tool can first identify users who “liked” or “favorited” an uploaded video on YouTube; then, the tool can check whether those users have similar content on YouTube or not. If those users have similar content, then the tool can use the tags used by those users as an additional source of data for keyword recommendation.

The obtained textual information from each of the aforementioned data sources is then filtered to discard redundant, irrelevant, or unwanted information. The filtered results may then be analyzed by a keyword recommendation algorithm to rank or score the obtained keywords. A final recommended set of tags may then be recommended to the content provider.

Extracting Information from Text-Based Sources

Various sources may be utilized to gather data from text-based sources. Such sources may include (but are not limited to) the following:
Encyclopedias, including but not limited to Wikipedia and Britannica;
Review websites, e.g., Rotten Tomatoes (RT) for movies and Giant Bomb for games;
Information from other videos, including but not limited to the title, description and tags of videos in online and offline video sharing databases (such as Youtube and Vimeo);
Blogs and news websites, such as CNN, TechCrunch, and TSN;
Educational websites, e.g., how-to websites and digital libraries; and
Information collected from web services and other software that generate tags and keywords from an input text, e.g., Calais and Zemanta.

The input data provided by the user (e.g., title, description, etc.) may be used to collect relevant documents from each of the selected data sources. In particular, for each textual source, N pages (entries) are queried (N is a design parameter, which might be set independently for each source). The textual information is then extracted from each page. The value of N for each source can be adjusted by any user of the supplemental keyword generation process, if needed.

Note that, depending on the data source, different types of textual information can be retrieved or extracted from the selected data source. For example, for Rotten Tomatoes, the movie's reviews or the movie's cast can be used as the source of information.

Extracting Textual Information from Videos

In addition to the textual data sources, the supplemental keyword generation process may extract information from videos. Various algorithms can be employed for this purpose. Examples include:

Optical Character Recognition;

Lyrics Recognition;

Object recognition (including logo recognition);

Face Recognition;

Scene recognition; and

Event recognition.

An optical character recognition (OCR) module can be utilized by the supplemental keyword generation process to detect and extract any potential text from a given video. The extracted text can then be processed to recommended keywords based on the obtained text. An OCR algorithm is proposed and described in more detail below.

A lyrics recognition module (LRM) can also be utilized by the supplemental keyword generation process. A lyrics recognition module employs the output texts returned by an OCR module to determine whether or not there exists specific lyrics on the video. This can be done by comparing the output text of the OCR module with lyrics stored in a database. If specific lyrics are detected in the video, the supplemental keyword generation process can then recommend keywords related to the detected lyrics. For example, if LRM finds that the uploaded video contains lyrics of a famous singer, then the name of the singer or the name of the relevant album or some relevant and important keywords from lyrics may be included in the recommended keywords. A lyrics recognition algorithm is described in more detail below.

The supplemental keyword generation process can also utilize an object recognition algorithm to examine whether the uploaded video contains specific objects or not. For instance, if the object recognition algorithm detects a specific object in the video (e.g., the products of a specific manufacturer or the logo of a specific company or brand), the name of that object can be used in the keyword recommendation process. For the purpose of object recognition, several different algorithms can be employed in the system. For example, the supplemental keyword generation process can utilize a robust face recognition algorithm for recognizing potential famous faces in the uploaded video so that the name of the recognized faces is included in the recommended keywords.

A scene recognition module can also be utilized in the supplemental keyword generation process to detect and recognize special places (e.g., famous buildings, historical places, etc.) or scenes or environments (e.g., desert, sea, space, etc.). The name of the detected places or scenes can then be used in the keyword recommendation process.

Similarly, the supplemental keyword generation process can employ a suitable algorithm to recognize special events (e.g., sport games, fireworks, etc.). The supplemental keyword generation process can then use the name of the recognized events to recommend keywords.

Extracting Textual Information from Audio

The audio portion of the video may also be analyzed by the supplemental keyword generation process so that more relevant keywords can be extracted. This may be achieved, for example, by using the following potential algorithms:
Speech recognition: The speech recognition algorithm recognizes the speech in the video and converts the speech to text. The text can then be processed by the keyword recommendation algorithm.
Speaker identification: The speaker recognition algorithm recognizes the speakers in the video and the name of the person can then be added to the recommended keywords.
Music recognition: The music recognition algorithm recognizes the music used in the video and then adds relevant keywords (e.g., the name of the composer, the artist, the album, or the song) to the suggested keywords.

Extracting Keywords Using Social Connections

An online video distribution system such as YouTube may allow its users to have a social connection or interaction with the uploaded video. For instance, users can “like,” “dislike,” “favorite” or leave a comment on the uploaded video. Such potential social connections to the video uploaded can also be utilized to extract relevant information for keyword recommendation. For instance, the supplemental keyword generation process can use the tags used by all users who have a social connection with the uploaded video as an additional source of information for keyword recommendation.

Keyword Filters

Once the raw data is extracted from some or all the sources, filtering may be applied before the text is fed to the keyword recommendation algorithm(s). To remove redundant keywords or those keywords that do not carry important information (e.g., stopwords, etc.), the text obtained from each of the employed data sources by the supplemental keyword generation process may be processed by one or more keyword filters. Several different keyword filters can be employed by the supplemental keyword generation process. Some examples include the following:
Remove Stop Words: This filter is used to remove stop words, i.e., any of a number of very commonly used keywords such as “the”, “am”, “is”, “are”, “of”, etc.
Remove short words: This filter is used to discard words whose length is shorter than or equal to a specified length (e.g., 2 characters).
Lowercase Filter: This filter converts all the input characters to lowercase.
Remove words that are not in dictionaries: This filter removes those keywords that do not exist in a given dictionary (e.g., English dictionary, etc.) or in a set of different dictionaries.
Black-List Filter: This filter removes those keywords that exist in a black list provided either by the user or generated automatically by a specific algorithm. An example of such algorithm is an algorithm that detects the name of persons or companies.
Markup Tags Filter: This filter is used to remove potential markup language tags (e.g., HTML tags) when processing the data collected from data sources whose outputs are provided in a structured format such as Wikipedia.

If more than one filter is applied, the above potential filters can be applied in any order or any combination. The results are sent to the recommendation unit of the supplemental keyword generation process so that the relevant keywords are generated.

Recommendation Unit(s)

The keyword recommendation unit(s) process the input text to extract the best candidate keywords and recommend them to a user. For this purpose, several different keyword recommendation processes can be employed. Some examples include the following keyword recommendation processes (or any combination of them):
Frequency-based Recommendation: consider the frequency of the keyword in the recommendation. Some examples include the following:
   Frequency Recommendation: collects words from a given text and recommends tags based on their frequency in the text (i.e., the number of times a word appears in the text).
   TF-IDF (Term Frequency-Inverse Document Frequency) Recommendation: collects candidate keywords from a given text and recommends tags based on their TF-IDF score. TF-IDF is a numerical statistic that reflects how important a word is to a document in a collection or corpus. This process is often used as a weighting factor in information retrieval and text mining. The TF-IDF value increases proportionally to the number of times a word appears in the document. However, the TF-IDF value is offset by the frequency of the word in the corpus, which compensates for the fact that some words are more common than others.
Probabilistic-based Recommendation: uses probability theory for recommendation. Some examples include:
   Random Walk-based Recommendation: collects candidate keywords from the specified data sources, builds a graph based on the co-occurrence of keywords in a given input text, and recommends tags based on their ranking according to a random walk process on the graph (e.g., using the PageRank algorithm). Note that the nodes in the created graph are the keywords that appear in the input test source, and there is an edge between every two keywords (nodes) that co-occur in the input text source. Also, the weight of each edge is set to the co-occurrence rate of the corresponding keywords.
   Surprise-based Tag Recommendation: detects those keywords in a given text that may sound surprising or interesting to a reader. Previously, a method for finding surprising locations in a digital video/image using several visual features extracted from the image/video was proposed in based on the Bayesian theory of probability. Bayesian surprise quantifies how data affects natural or artificial observers, by measuring differences between posterior and prior beliefs of the observer, and it can attract human attention. The surprise-based tag recommendation process works based on a similar idea, however, it is designed specifically for the purpose of keyword recommendation. In this recommendation process, given an input text, a Bayesian learner is first created. The prior probability distribution of the Bayesian learner is estimated based on the background information of a hypothetical observer. For instance, the prior probability distribution can be set to a vague distribution such as a uniform distribution so that all keywords look not-surprising or not-interesting to the observer at first. When a new keyword comes in (i.e., when new data is observed), the Bayesian learner updates its prior belief (i.e., its prior probability distribution) based on the Bayes's theorem so that the posterior information is obtained. The difference between the prior and posterior is then considered as the surprise value of the new keyword. This process is repeated for every keyword in the input text. At the end of the process, those keywords whose surprise value is above a specific threshold are recommended to the user.
Conditional Random Field (CRF)-based Tag Recommendation: suggests keywords by modeling the co-occurrence patterns and dependencies among various tags/keywords (e.g., the dependency between “Tom” and “Cruise”) in a given text using a conditional random field (CRF) model. The relation between different text documents can also be modeled by this recommendation process. The CRF model can be applied on several arbitrary non-independent features extracted from the input keywords. Hence, depending on the extracted feature vectors, different levels of performance can be achieved. In this recommendation process, the input feature vectors can be built based on the co-occurrence rate between each pair of keywords in the input text, the term frequency (tf) of each keyword within the given input text, the term frequency of each keyword across a set of similar text documents, etc. This recommendation process can be trained by different training data sets so as to estimate the CRF model's parameters. The trained CRF model can then score different keywords in a given test text so that a set of top relevant keywords can be recommended to the user.
Synergy-based or Collaborative-based Tag Recommendation: analyzes the uploaded video by some specific processes (e.g., text-based search video or audio fingerprinting methods) to find some similar already-tagged videos in some specific data sources (e.g., YouTube), and uses their tags in the keyword recommendation process. In particular, the system can use the tags of those videos that are very famous (e.g., those videos in YouTube whose number of views is above a specific value). The system can also recommend keywords based on social connections (e.g., keywords from recently watched videos by a user's Facebook friends, etc).
Crowdsourcing-based Tag Recommendation: uses a human expert in the loop for keyword recommendation. For instance, some knowledgeable experts can be recruited from a relevant company such as Amazon Mechanical Turk to either suggest keywords or to help decide which keywords are better for the uploaded video.
Search-Volume-based Tag Recommendation: uses tags extracted from the keywords used to search for a specific piece of content in a specific data source (e.g., YouTube). In particular, the system can utilize those keywords that have been searched a lot for retrieving a specific piece of content (e.g., those keywords whose search volume (search traffic) is above a certain amount).

Such potential keyword recommendation processes can be executed either serially or in parallel or a mixture of both. For instance, the output of one recommendation process can be served as the input to another recommendation process while the other recommendation processes are executed in parallel.

Each of the aforementioned potential recommendation processes produces a list of tags of arbitrary length. Online video distribution systems such as YouTube may restrict the total length (in characters) of the keywords that can be utilized by users. For instance, the combined length of the keywords in a video sharing website such as YouTube might be restricted to k=500 characters. In order to satisfy this restriction, a subset of all the recommended keywords may be selected by the supplemental keyword generation process. This goal can be achieved using several different algorithms. Examples of such keyword selection algorithms are shown below.

A Knapsack-Based Keyword Recommendation Algorithm

In a Knapsack-based keyword recommendation algorithm, a keyword recommendation problem can be formulated as a binary (0/1) knapsack problem in which the capacity of the knapsack is set to k=500, the profit of each item (keyword) is set to the keyword score computed by the recommendation unit, and the weight of each item (keyword) is set to the length of the keyword. The knapsack problem can then be solved by an appropriate algorithm (e.g., a dynamic programming algorithm) so that a set of best keywords can be found that maximize the total profit (score) while their total weight (length) is below or equal to the knapsack capacity.

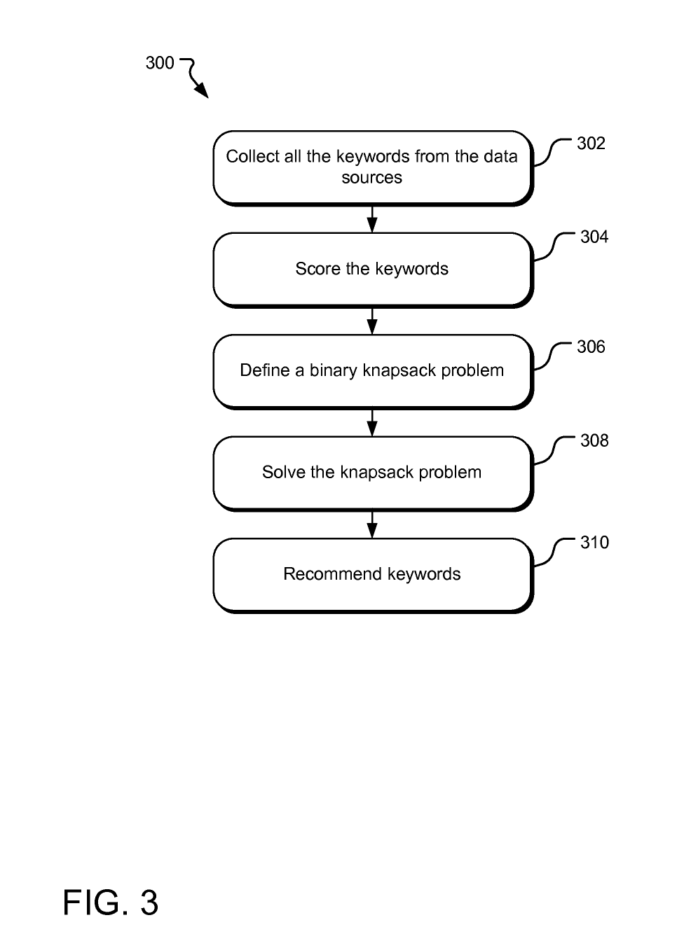

FIG. 3 shows a flowchart of the knapsack-based keyword recommendation algorithm. In operation 302, all the keywords are collected from the data sources. In operation 304, the keywords are scored. In operation 306, a binary knapsack problem is defined. In operation 308, the knapsack problem is solved. Finally, in operation 310, keyword(s) are recommended.

A Greedy-Based Keyword Recommendation Algorithm

The aforementioned knapsack-based method can obtain the optimal set of keywords based on the specified capacity, however, it may be very time consuming. As an alternative, one can use a greedy-based algorithm such as the following algorithm to find the keywords in a shorter time:

Step 1: Compute the score of each keyword in all the text documents obtained from each data source based on the score used by the specified recommendation algorithm.

Step 2: Depending on the category of the video, the importance (weight) of data sources can change. Therefore, multiply the scores of keywords of each data source by the weight of that data source.

Step 3: Sort all the collected keywords from all data sources based on their weighted score.

Step 4: Starting from the keyword whose score is the highest in the sorted list, recommend keywords until the cummulative length of the recommended keywords is equal to k characters.

The weight of each data source can be determined using manual tuning (by a human) or automated tuning methods until the desirable (optimal) set of keywords are determined.

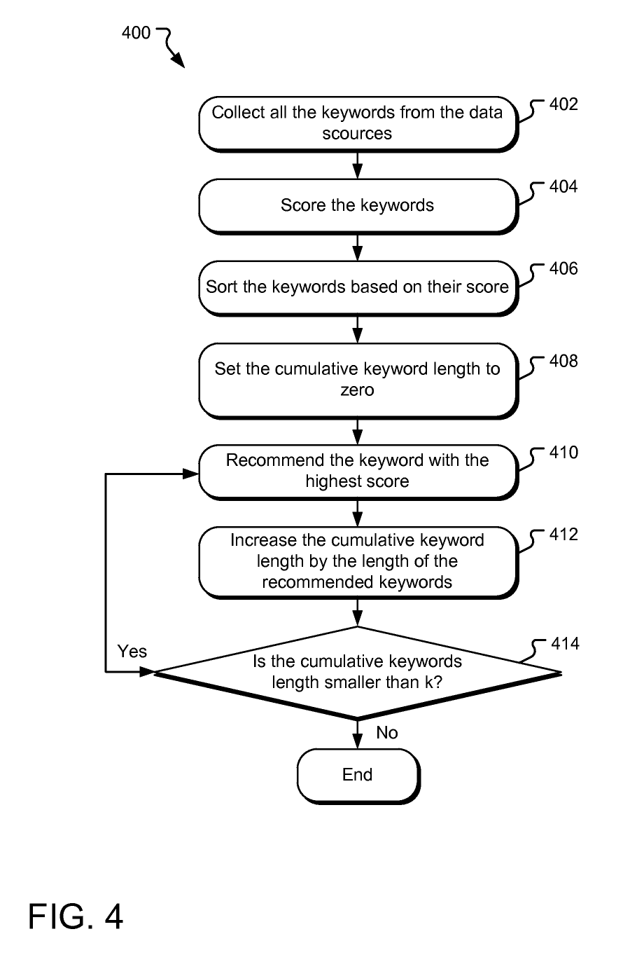

FIG. 4 shows the flowchart of an example of a greedy-based keyword recommendation algorithm. In operation 402, all the keywords are collected from the data sources. In operation 404, the keywords are scored. In operation 406, the keywords are sorted based on their score. In operation 408, a cumulative keyword length is set to zero. In operation 410, the keyword with the highest score is recommended. In operation 412, the cumulative keyword length is increased by the length of the recommended keywords. In operation 414, the computer tests whether the cumulative keyword length is smaller than “k.” If the cumulative keyword length is smaller than “k,” then the process again repeats operation 410. If the cumulative keyword length is larger or equal to “k,” then the process ends.

Aggregating Keywords Generated by Different Keyword Recommendation Processes

In practice, a keyword recommendation system can employ more than one keyword recommendation process for obtaining a better set of recommended keywords. Hence, the keywords generated by different keyword recommendation processes can be aggregated. Several different processes can be utilized for this purpose. For instance, the following process can be used to achieve this goal:

Step 1: Assign a specific weight to each keyword recommendation process. This weight determines the importance or the amount of the contribution of the relevant recommendation process. One way that such weighting can be set is by conducting user study experiments.

Step 2: Obtain the keywords recommended by all the applied keyword recommendation processes along with their scores.

Step 3: Normalize the scores of the recommended keywords of each keyword recommendation process (e.g., between 0 and 100).

Step 4: Scale the normalized scores of each recommendation process by the weight of the recommendation process as specified in Step 1.

Step 5: Apply the keyword recommendation process (e.g., the knapsack-based process) on all the keywords obtained from the employed recommendation processes using the scaled normalized keyword scores computed in Step 4.

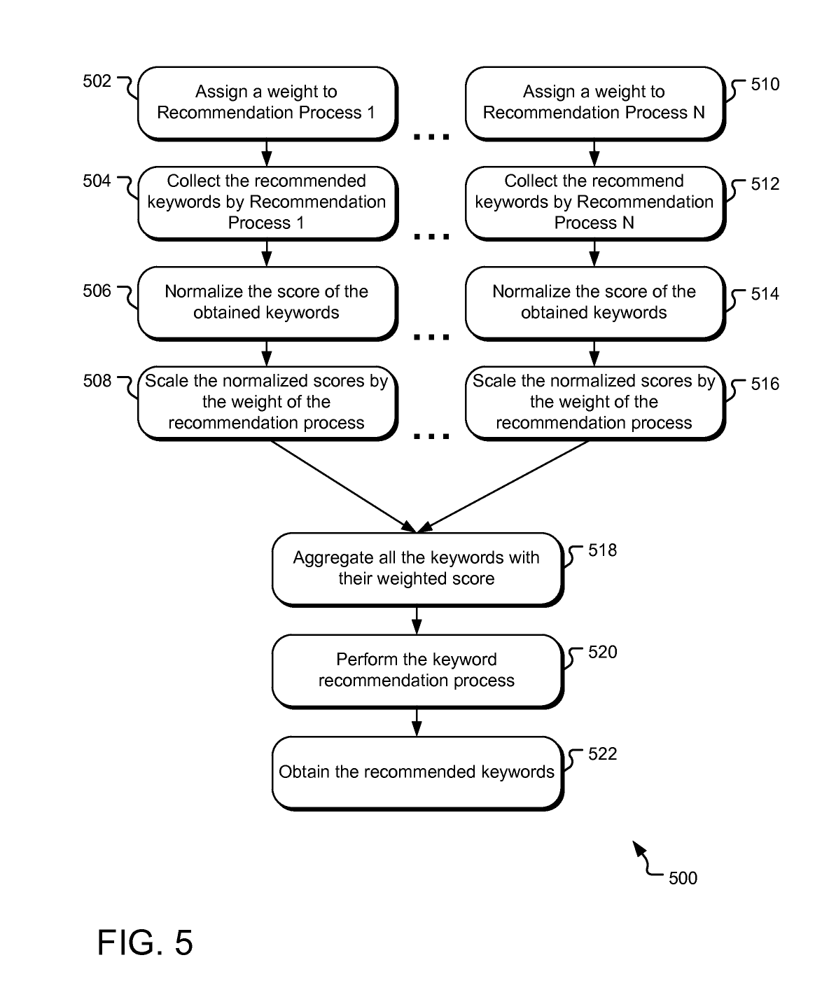

FIG. 5 shows a block diagram of an example process for aggregating the keywords generated by different keyword recommendation processes. In FIG. 5, a weight is assigned to recommendation process #1, as shown by operation block 502. In operation 504, the recommended keywords are collected by recommendation process #1. In operation block 506, the score of the obtained keywords are normalized. In operation 508, the normalized scores are scaled by the weight assigned to the recommendation process. This process is repeated for each recommendation process such that a scaled value can be input into operation 518. Thus, FIG. 5 shows that a weight is assigned to recommendation process #N in operation 510. In operation 512, the recommended keywords are collected by recommendation process #N. In operation 514, the score of the obtained keywords is normalized. In operation 516, the normalized scores are scaled by the weight of the recommendation process #N.

In operation 518, the keywords are aggregated with their weighted score. In operation 520, a keyword recommendation process is performed on the aggregated keywords. Finally, the recommended keywords can be obtained for recommendation in operation 622.

A Process for Finding Top Recommended Keywords

In order to find a set of the top recommended keywords, various processes can be utilized. The following process is one example:

Step 1: Normalize all the obtained scores between min and max. An example of this is to set min=0 and max=100.

Step 2: Starting from a high initial threshold T (e.g., T=0.95*max), find those keywords whose score is above the threshold. Let L be the number of found keywords in this step.

Step 3: If L is larger than a minimum threshold M, stop; Otherwise, reduce T by a small value (e.g., 0.05*max) and go to Step 2.

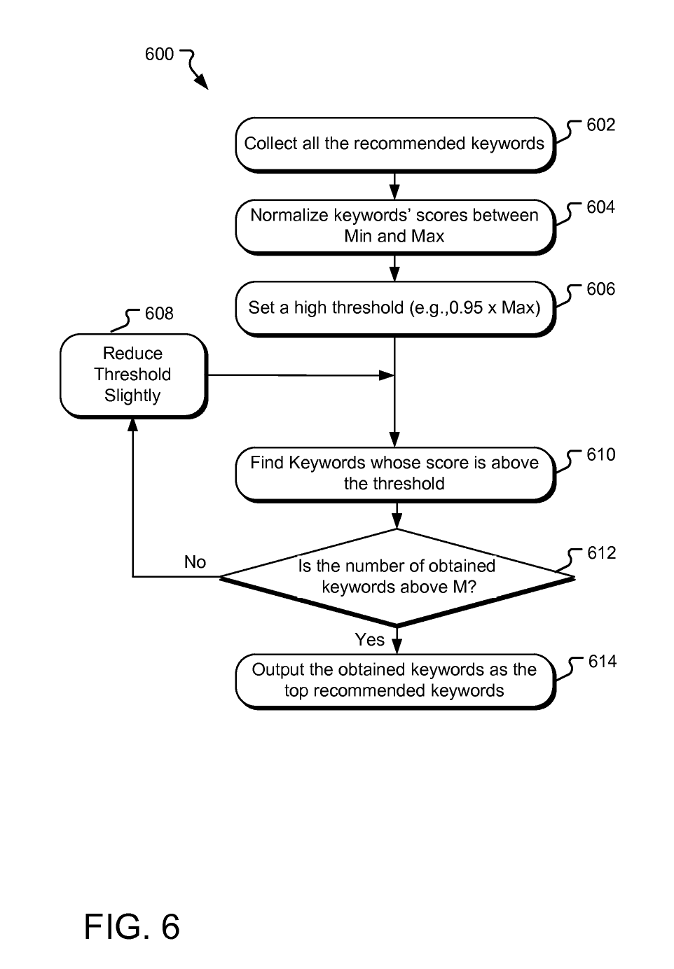

In the above process, M specifies the minimum number of keywords that may be in the list of the top recommended keywords (e.g., M=15). The obtained set at the end of the aforementioned process contains the top recommended keywords. Note that other processes can also be utilized for finding the top recommended keywords. FIG. 6 shows an example for this process:

In FIG. 6, all the recommended keywords are collected, as shown in operation 602. In operation 604, the scores of the keywords are normalized between Min and Max values. In operation 606, a high threshold is set (e.g., 95% of Max value). In operation 610, a search is conducted for keywords that have a score above this threshold. In operation 612, a determination is made of whether the number of obtained keywords is above M. If the number of obtained keywords is not above M, the process operation 608 is conducted, where the threshold is reduced slightly, e.g., by a predetermined percentage. If the number of obtained keywords is above M, the process outputs the obtained keywords as the top recommended keywords.

Optical Character Recognition (OCR) Module

One implementation of an optical character recognition (OCR) module is illustrated below. An OCR module can extract and recognize text in a given image or video. For video, each frame of the video can be treated as a separate static image. However, since a video consists of several hundred video frames and the same text may be displayed over several consecutive frames, it might not be necessary to process all the frames. Instead, a smaller subset of video frames can be processed for text extraction. The OCR module can localize and extract text information from an image or video frames. Moreover, the OCR module can process both images with plain background as well as images with complex background.

The OCR module may consist of the following four main modules:

Text Detection and Localization;

Text Boundary Refining (Region Refining);

Text Extraction; and

OCR (Optical Character Recognition).

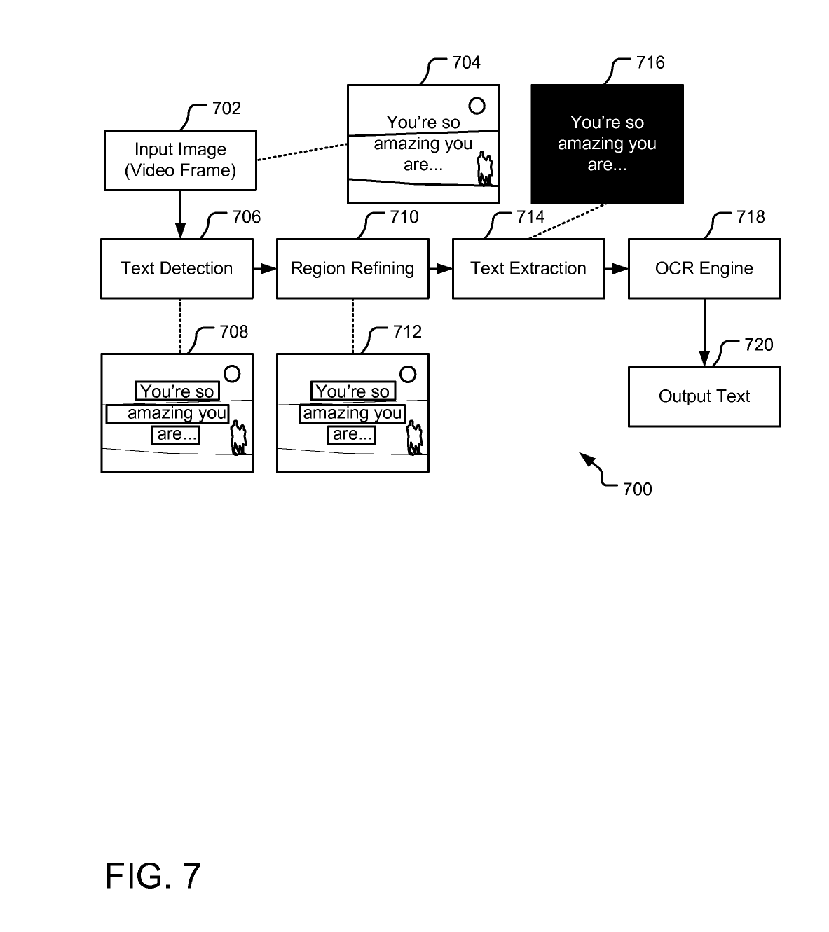

Depending on the application, one or more of the aforementioned modules can arbitrarily be removed from the system. Other modules can also be added to the system. A block-diagram 700 of one implementation of the OCR module is shown in FIG. 7. An input video image 704 is input to an input stage 702 of the OCR process. A text detection stage can then process the image to detect and localize potential text areas. The output of the text detection stage is shown as modified image 708. The detected text regions can then be refined by a region refining stage 710. The output of the region refining stage is shown as image 712. A text extraction stage 714 can then extract the text from the background image. The output of the text extraction stage is shown as image 716. An OCR engine 718 may then extract the text from the image so as to obtain a character based representation of the text. The text is output by the output text stage 720.

A sample output of each stage is shown as an image connected with a dashed line to the relevant module.

Stage 1: Text Detection and Localization

The text detection and localization stage detects and localizes text regions of an input image. The edge map of the given input image in each of the Red, Green, and Blue color spaces (called RGB channels) is first computed separately. The edge map contains the edge contours of the input image, and it can be computed by various image edge detection algorithms. The obtained three edge maps can then be combined together with a logical OR operator in order to get a single edge map. However, in other implementations, each of the individual edge maps in the RGB space, the edge map in the grayscale domain, edge maps in the different color spaces such as Hue Saturation Intensity (HSI) and Hue Saturation Value (HSV) and any combination of them with different operators such as logical AND or logical OR might be used.

The obtained edge map is then processed to obtain an “extended edge map”. One method of implementation is that the process starts scanning the input edge map line by line in a raster-scan order, and connects every two non-zero edge point whose distance is smaller than a specific threshold. The threshold can then be computed as a fraction of the input image width (e.g., 20%). The text regions are rich in edge information, and the edge location of different characters (or words) are very close to each other. Therefore, different characters (or words) can be connected to each other in the extended edge map.

The extended edge map is then fed to a connected-component analysis to find isolated binary objects (called blobs). In particular, the bounding box of each blob is computed, which allows the system to locate characters (or words). Several geometric properties of the blobs (e.g., blob width, blob height, blob aspect ratio, etc.) can then be extracted. Those blobs whose geometric properties satisfy one or more of the following conditions are then removed. Some of the conditions that can be implemented are as follows:

The blob is very thin (horizontally or vertically).

The aspect ratio of the blob is larger or smaller than a specific pre-determined threshold.

The blob area is smaller or larger than a specific threshold.

After filtering the redundant or erroneous blobs, a smaller set of candidate blobs is obtained. The bounding boxes of the remaining blobs are then used to localize potential text regions, where the bounding box of a blob is the smallest rectangular box around the blob, which encloses the blob.

Stage 2: Text Boundary Refining (Region Refining)

The text boundary refining stage fine-tunes the boundaries of the obtained text regions. To achieve this goal, the horizontal and vertical histogram of edge points in the edge map of the input image are computed. The first and the last peak in the horizontal histogram are considered as the actual left and right boundaries of the detected text region, respectively. Similarly, the first and the last peak in the vertical histogram are considered as the actual top and bottom boundary of the detected text region, respectively. This way, the boundaries of the detected text regions are fine-tuned automatically. FIG. 7 shows an example of located text regions after being refined by the proposed text boundary refining method. Highlighted regions in the image attached to the Region Refining block show the detected text regions.

Stage 3: Text Extraction

The OCR module can employ an OCR engine (library). The OCR engine receives binary images as its input. The text extraction module provides such a binary image by binarizing the input image within the detected text regions using a specific thresholding process. Non-text regions are set to black (zero) by the text extraction process.

The thresholding process implemented in the OCR module gets the input image (the extracted text region) in RGB format, considers each color pixel as a vector, and clusters all vectors (or pixels) in the given text region into two separate clusters using a clustering process. One way of implementing this clustering process is via the K-Means clustering process. The idea here is that characters in an image share the same (or very similar) color content while the background contains various colors (possibly very different from the color of characters). Therefore, one can expect to find the pixels of all characters in the input text region in one class, and the background pixels in another. To find out which of the obtained two classes contains the characters of interest, two binary images are created. In the first binary image, all pixels that fall in the first class are set to Label A, and others are set to Label B. Similarly, in the second binary image, all pixels that fall in the second class are set to Label B, and other pixels are set to Label A. One example of Label A is the binary number 1 and one example of Label B is the binary number 0. A separate connected-component analysis is then performed on each of these two binary images, and the number of valid blobs inside them is counted. The same criteria as in Stage 1 is used for finding the valid blobs. The class whose corresponding binary image has more valid blobs is then considered as the class that contains the characters. This is because the background is usually uniform, and has fewer isolated binary objects. Using this approach, we can create a binary image to be used by the OCR engine. FIG. 7 shows one example of the result of the text extraction method.

Stage 4: Optical Character Recognition (OCR)

Any OCR engine can be employed for text recognition in the OCR module. One example is the Tesseract OCR engine. Some OCR engines expect to receive an input image with plain background. Therefore, if the input OCR image contains complex background, the engine cannot recognize the potential texts properly. With the above-described text localization and extraction method the process can remove the potential complex background of the input image as much as feasible so as to increase the accuracy and performance of the OCR engine. Hence, the above-described text localization and extraction method can be considered as a pre-processing step for the OCR engine. The output of the OCR engine when the image depicted in FIG. 7 is fed to the OCR engine is “You're so amazing you are . . . ”. The string(s) returned by this stage is considered as the text inside the input image or video frame.

The Lyrics Recognition Module (LRM)

The lyrics recognition module (LRM) employs the OCR module described above to check whether a specified lyrics exists in a given video or not. Various processes can be employed for lyrics recognition.

In accordance with one implementation, let V be a given video sequence consisting of M video frames. To reduce the computational complexity, the input video V might be subsampled to obtain a smaller subset of video frames S whose length is N<<M. Each video frame in S is then fed to the OCR module to obtain any potential text within it.

Let Tᵢ be the extracted text of the ith sampled frame in S, and R be a given lyrics. In order to find the similarity/relevance of Tᵢ to R, the specified lyrics R is scanned by a moving window of length Lᵢ with a step of one word, where Lᵢ is the length of Tᵢ. Here, we assume that words are separated by space. Let Rⱼ be the text (lyrics portion) that falls within the j^{th} window over R. The Levenstein distance (a metric for measuring the amount of difference between two text sequences) between Tᵢ and Rⱼ, LV(Tᵢ, Rⱼ) is then calculated. Other metrics which can measure the distance between two text strings might also be employed here. Afterwards, the minimum distance of Tᵢ with respect to R, dᵢ is computed as

dᵢ=minⱼLV(Tᵢ,Rⱼ),

where j is taken over all possible overlapping windows of length Lᵢ over R. The computed distance is stored. The same procedure is then repeated for each extracted video frame. After processing the extracted N frames, the final distance between the extracted texts and the original lyrics, d, is calculated as the average of the obtained N minimum distances,

dᵢ, i=1, . . . , N.

For the purpose of lyrics recognition, the obtained final distance, d, of a given video may be compared with a specific pre-determined threshold, t₀. One way of obtaining this threshold is by plotting the precision-recall (PR) and ROC (Receiver Operating Characteristic) curves for a number of sample lyrics in a ground truth database. The PR and ROC curves are generated by varying threshold t₀ over a wide range. Hence, each point on the PR and ROC curves corresponds to a different threshold t₀. A proper threshold is the one whose true positive rate (in the ROC curve) is as large as possible (e.g., above 90%) while its corresponding false positive rate (in the ROC curve) is as small as possible (e.g., below 5%). Also, a good threshold results in a very high precision and recall values. Hence, by looking at the precision-recall and ROC curves of a number of sample lyrics, a proper value for t₀ can be found experimentally. Afterwards, any video whose final distance, d, is smaller than t₀ can be said to contain the lyrics of interest.

The keyword generation processes described herein may be applied once. However, in another embodiment, the system might apply the proposed keyword generation processes continuously over time, so that good keywords are always recommended to the user. The frequency of updating the keywords is a parameter that can be set internally by the system or by the user of the system (e.g., update the tags of the video once every week).

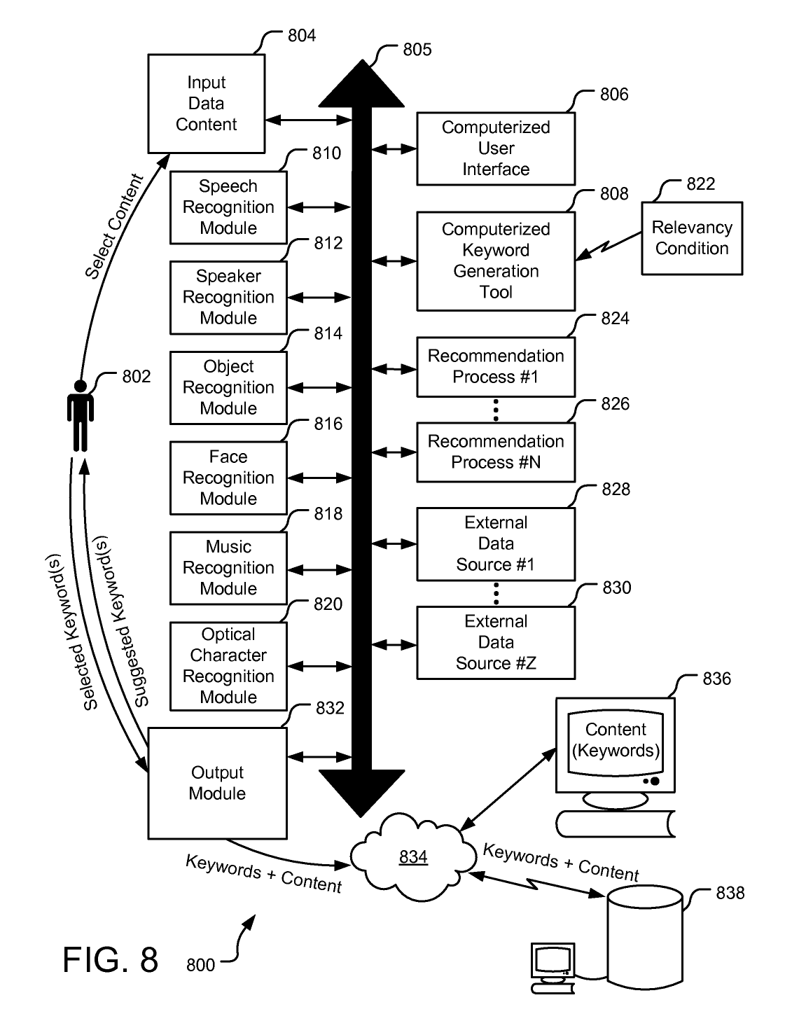

FIG. 8 illustrates a system 800 for generating keyword(s) in accordance with one embodiment. User 802 first selects content for which keyword(s) should be generated. The content can serve as the input data itself. Alternatively or additionally, other data related to the content can serve as input data to the keyword generation process. For example, a title of the content, a description of the content, a transcript of a video, or tags suggested by the user can serve as such related data. A bus 805 is shown coupling the various components of the system. A computerized user interface 806 is coupled with the input data content device 804. The computerized user interface device allows the user to interface with the keyword generation process so as to input data and receive data.

A computerized keyword generation tool is shown as block 808. The keyword generation tool can utilize the supplied data as well as operate on the supplied input data so as to determine additional input data. For example, speech recognition module 810, speaker recognition module 812, object recognition module 814, face recognition module 816, music recognition module 818, and optical character recognition module 820 can operate on the input data to generate additional data.

The computerized keyword generation tool 808 operates on the input data to generate suggested keyword(s) for the content. In one aspect, the computerized keyword generation tool utilizes a relevancy condition 822 to select external data sources. For example, a user supplied category for the input content, such as “movie”, can serve as the relevancy condition. The keyword generation tool selects relevant external data source(s) 828 through 830 based on the relevancy condition to determine potential keyword(s). In some embodiments, the relevancy condition might be supplied from a source other than the user. Moreover, the computerized keyword generation tool can utilize recommendation process(es) 824 through 826 to recommend keywords, as explained above. The recommendation processes may utilize speech recognition module 810, speaker recognition module 812, object recognition module 814, face recognition module 816, music recognition module 818, and optical character recognition module 820 in some instances.

An output module 832 is shown outputting suggested keyword(s) to the user (e.g., via the computerized user interface 806). The user is shown as selecting keyword(s) from the suggested keywords that should be associated with the content. The output module is also shown outputting the content and selected keywords to a server 838 on a network 834. The server is shown serving a website page with the content as well as the selected keyword(s) (e.g., the selected keyword(s) can be stored as metadata for the content on the website page). The website page is shown on a third party computer 836 where the content is displayed and the selected keywords are hidden.

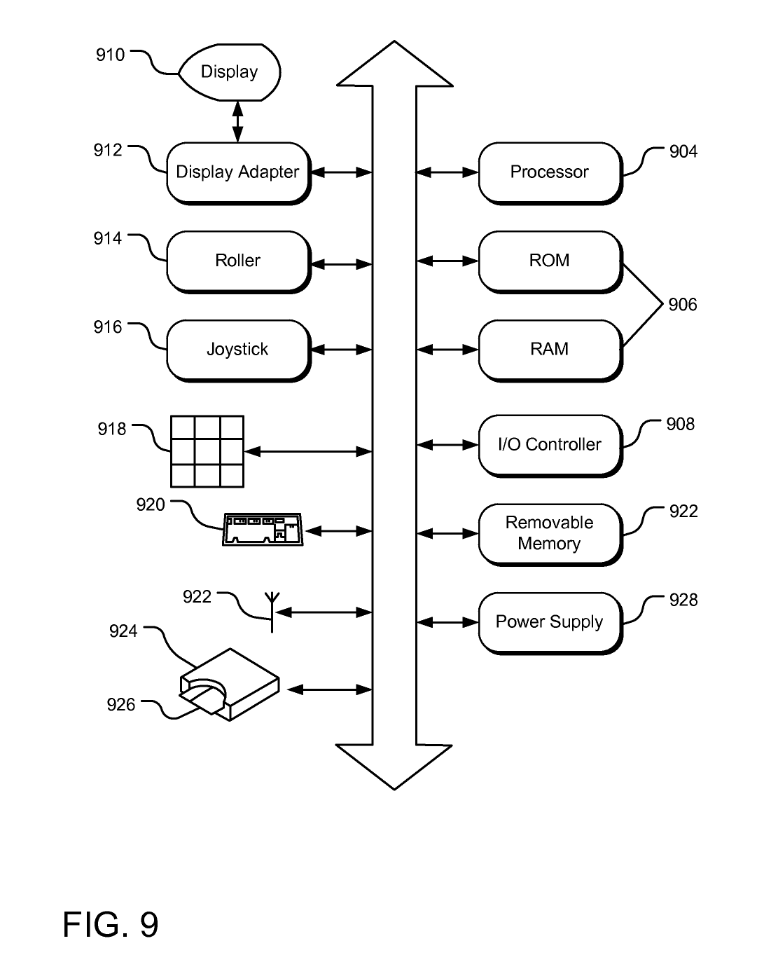

FIG. 9 discloses a block diagram of a computer system 900 suitable for implementing aspects of the processes described herein. The computer system 900 may be used to implement one or more components of the supplemental keyword generation system disclosed herein. For example, in one embodiment, the computer system 900 may be used to implement each of the server 902, the client computer 908, and the supplemental keyword generation tool stored in an internal memory 906 or a removable memory 922. As shown in FIG. 9, system 900 includes a bus 902 which interconnects major subsystems such as a processor 904, internal memory 906 (such as a RAM or ROM), an input/output (I/O) controller 908, removable memory (such as a memory card) 922, an external device such as a display screen 910 via a display adapter 912, a roller-type input device 914, a joystick 916, a numeric keyboard 918, an alphanumeric keyboard 920, smart card acceptance device 924, a wireless interface 926, and a power supply 928. Many other devices can be connected. Wireless interface 926 together with a wired network interface (not shown), may be used to interface to a local or wide area network (such as the Internet) using any network interface system known to those skilled in the art.

Many other devices or subsystems (not shown) may be connected in a similar manner. Also, it is not necessary for all of the devices shown in FIG. 9 to be present to practice an embodiment. Furthermore, the devices and subsystems may be interconnected in different ways from that shown in FIG. 9. Code to implement one embodiment may be operably disposed in the internal memory 906 or stored on non-transitory storage media such as the removable memory 322, a floppy disk, a thumb drive, a CompactFlash® storage device, a DVD-R (“Digital Versatile Disc” or “Digital Video Disc” recordable), a DVD-ROM (“Digital Versatile Disc” or “Digital Video Disc” read-only memory), a CD-R (Compact Disc-Recordable), or a CD-ROM (Compact Disc read-only memory). For example, in an embodiment of the computer system 900, code for implementing the supplemental keyword generation tool may be stored in the internal memory 906 and configured to be operated by the processor 904.

In the above description, for the purposes of explanation, numerous specific details are set forth in order to provide a thorough understanding of the embodiments described. It will be apparent, however, to one skilled in the art that these embodiments may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential, as other embodiments may omit such features.

In the interest of clarity, not all of the routine functions of the embodiments described herein are shown and described. It will, of course, be appreciated that in the development of any such actual embodiment, numerous implementation-specific decisions must be made in order to achieve the developer's specific goals, such as compliance with application- and business-related constraints, and that those specific goals will vary from one embodiment to another and from one developer to another.

According to one embodiment, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment, the components, processes and/or data structures may be implemented using machine language, assembler, PHP, C or C++, Java, Perl, Python, and/or other high level language programs running on a data processing computer such as a personal computer, workstation computer, mainframe computer, or high performance server running an OS such as Solaris® available from Sun Microsystems, Inc. of Santa Clara, Calif., Windows 8, Windows 7, Windows Vista™, Windows NT®, Windows XP PRO, and Windows® 2000, available from Microsoft Corporation of Redmond, Wash., Apple OS X-based systems, available from Apple Inc. of Cupertino, Calif., BlackBerry OS, available from Blackberry Inc. of Waterloo, Ontario, Android, available from Google Inc. of Mountain View, Calif. or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The above specification, examples, and data provide a complete description of the structure and use of exemplary embodiments. Furthermore, structural features of the different implementations may be combined in yet another implementation.

What is claimed is:

1. A method comprising:
utilizing input data related to content to identify one or more data sources different from the content itself;
collecting additional content from at least one of the one or more data sources as collected content;
generating by a processor at least one keyword based at least on the collected content and at least one relevancy condition.

2. The method of claim 1, wherein the input data comprises at least one of title, description, transcript of a video, or tags recommended by a provider of the content.

3. The method of claim 1 wherein at least some of the input data is extracted from the content.

4. The method of claim 3 wherein the input data is extracted from the content using at least one of a speech recognition module, a speaker recognition module, an object recognition module, a face recognition module, an optical character recognition module, or a music recognition module.

5. The method of claim 3 wherein the input data extracted from the content is textual data.

6. The method of claim 1, and further comprising suggesting at least one keyword to a user.

7. The method of claim 1 and further comprising utilizing the at least one keyword as metadata on a website in association with the content.

8. The method of claim 1 wherein the generating by a processor at least one keyword comprises generating a plurality of keywords, the method further comprising outputting the plurality of keywords for selection by a user.

9. The method of claim 1 wherein the one or more data sources are text-based, video-based, audio-based, or social-computer-network based data sources.

10. The method of claim 1 wherein generating by the processor at least one keyword comprises utilizing a knapsack-based keyword recommendation process.

11. The method of claim 1 wherein generating by the processor at least one keyword comprises utilizing a Greedy-based keyword recommendation process.

12. The method of claim 1 and further comprising aggregating a plurality of keywords generated by two or more keyword generators.

13. A system comprising:
a computerized user interface configured to accept input data relating to content; and
a computerized keyword generation tool configured to utilize the input data to collect additional content from at least one or more data sources different from the content itself and to generate one or more keywords based on at least the collected content and at least one relevancy condition.

14. The system of claim 13 wherein the input data comprises at least one of title, description, transcript of a video, or tags recommended by a provider of the content.

15. The system of claim 13 wherein at least some of the input data is extracted from the content.

16. The system of claim 15 wherein at least a portion of the input data is extracted from the content using at least one of a speech recognition module, a speaker recognition module, object recognition module, face recognition module, optical character recognition module, or a music recognition module.

17. The system of claim 13 and further comprising a computerized output module configured to output at least one suggested keyword to a user.

18. The system of claim 13 and further comprising a website utilizing the keyword as metadata in association with the content.

19. The system of claim 13 wherein the computerized keyword generation tool is configured to generate a plurality of keywords and wherein an output module is configured to output the plurality of keywords for selection by a user.

20. The system of claim 13 wherein the one or more data sources are text-based, video-based, audio-based, or social-computer-network based data sources.

21. The system of claim 13 wherein the computerized keyword generation tool utilizes at least a knapsack-based keyword recommendation process.

22. The system of claim 13 wherein the computerized keyword generation tool utilizes at least a Greedy-based keyword recommendation process.

23. The system of claim 13 wherein the computerized keyword generation tool aggregates a plurality of keywords generated by two or more keyword generation processes.

24. One or more computer-readable storage media encoding computer-executable instructions for executing on a computer system a computer process, the computer process comprising:
utilizing input data related to content to identify one or more data sources different from the content itself;
collecting additional content from at least one of the one or more data sources as collected content;
generating by a processor at least one keyword based at least on the collected content and at least one relevancy condition.
